(19) United States
(12) Patent Application Publication
(10) Pub. No.: US 2013/0340621 A1
(43) Pub. Date: Dec. 26, 2013

(54) COALESCING FILTER DEVICE FOR COLLECTING MIST AND EXTRACTING PARTICLES

(71) Applicants: Richard Tanis, Fennville, MI (US); Rodney Tanis, Hudsonville, MI (US)

(72) Inventors: Richard Tanis, Fennville, MI (US); Rodney Tanis, Hudsonville, MI (US)

(21) Appl. No.: 13/905,324

(22) Filed: May 30, 2013

Related U.S. Application Data
(60) Provisional application No. 61/663,094, filed on Jun. 22, 2012.

(51) Int. Cl. B01D 50/00

(52) U.S. Cl. CPC B01D 50/006
USPC 96/142; 55/472; 96/361

(57) ABSTRACT

A coalescing filter device that extracts harmful particles and mist from the air. The coalescing filter device may include a housing with a coalescing filter suspended within the housing. The coalescing filter may be suspended at an angle relative to the housing, such as a 45 degree angle. A blower may be attached to the top of the housing and may blow air from the inside of the housing to the outside. A bag filter may be sealed to the top of the coalescing filter and a charcoal filter may be secured to the housing in between the blower and the bag filter.

### BACKGROUND OF THE INVENTION

The present invention relates to a filter device and, more particularly, to a coalescing filter that collects mist and extracts harmful particles.

Oil mist, smoke, micro sized particulate, odors and light gasses are created by the common manufacturing processes using oils, coolants other liquids and solids that become atomized by the manufacturing process. The atomization of these materials permits or enables particulate to remain airborne in a manufacturing area and causes many kinds of issues. These issues range from discoloration or contamination of the end products and the facility caused by the accumulation of uncollected particles, to uncontrolled substances being ingested or absorbed by inhabitants of the manufacturing area causing respiratory and skin irritation problems.

Currently, other units that attempt to remedy the above issues are high maintenance due to spinning drums, low capacity filter pads, filters that are not capable of removing chemicals or electrostatic systems that require constant cleaning. When cast iron is machined, coolant is used to flush away the chips while the dust escapes out of the top of the machine. Dry systems cannot cope with the muddy air which coats paper filter surfaces. Devices that use the centrifugal method cannot remove smoke or light gasses. Further, other devices may have the filters vertical or flat, which is not efficient.

As can be seen, there is a need for a filtering device that properly filters contaminated mists.

### SUMMARY OF THE INVENTION

In one aspect of the present invention, a filtering device comprises: a housing having a bottom portion and a top portion, wherein the bottom portion comprises an intake; a coalescing filter suspended within the housing, wherein the coalescing filter is suspended at an angle relative to the housing; a blower attached near the top portion of the housing, wherein the blower blows air from the housing and thereby creates a vacuum within the housing.

These and other features, aspects and advantages of the present invention will become better understood with reference to the following drawings, description and claims.

### BRIEF DESCRIPTION OF THE DRAWINGS

FIG. 1 is a schematic side view of the present invention; and

FIG. 2 is a detail schematic side view of the housing portion of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a coalescing filter device that extracts harmful particles and mist from the air. The coalescing filter device may include a housing with a coalescing filter suspended within the housing. The coalescing filter may be suspended at an angle relative to the housing, such as a 45 degree angle. A blower may be attached to the top of the housing and may blow air from the inside of the housing to the outside. A bag filter may be sealed to the top of the coalescing filter and a charcoal filter may be secured to the housing in between the blower and the bag filter.

In certain embodiments, the present invention may include about a 6 inch thick expanded wire coalescing filter on about a 45 degree angle inside a housing that may be about 22% larger in size than an inlet. A process referred to as “triaxial deceleration” may occur, which may cause the air mass entering the device to be separated by pressure, in which the heavier particles fall to the lower portion of the airstream, while the smaller particles remain higher on the filter surface where the velocity is greater. The particles may be forced apart by vortices that occur, creating micro low pressure areas in a 3D fashion when the air mass passes through a first filter. Once the moisture is removed, any dry particulate that remain may be filtered out of the air stream.

The process may be done in parallel with the coalescing filter and a 95% filter made of a material that may be free flowing so that the air mass does not slow and may maintain an acceptable velocity. The air may then continue through an activated charcoal filter, removing light gases and odors. Because the filtering elements may be separated the filter life may be about 6 to 12 times longer and the unit may not be susceptible to aggregate damage.

When the system is used in an application such as machining cast iron or other particle generating processes, the air may first be drawn through a tube containing a conical nozzle that creates a thin cone of liquid such as water or coolant. This extracts the large particulate from the airflow, effectively filtering the particulate out of the air. The coolant then returns to the central tank with the particulate in tow. The air may then continue into the mist collecting device described below.

The present invention may be quieter and has a low cost of operation. Once installed, the present invention may require no maintenance for months and then only a few minutes to change two of the three filters. The present invention may use the conical spray inlet to remove particles such as cast iron that are nearly impossible to filter in any other way.

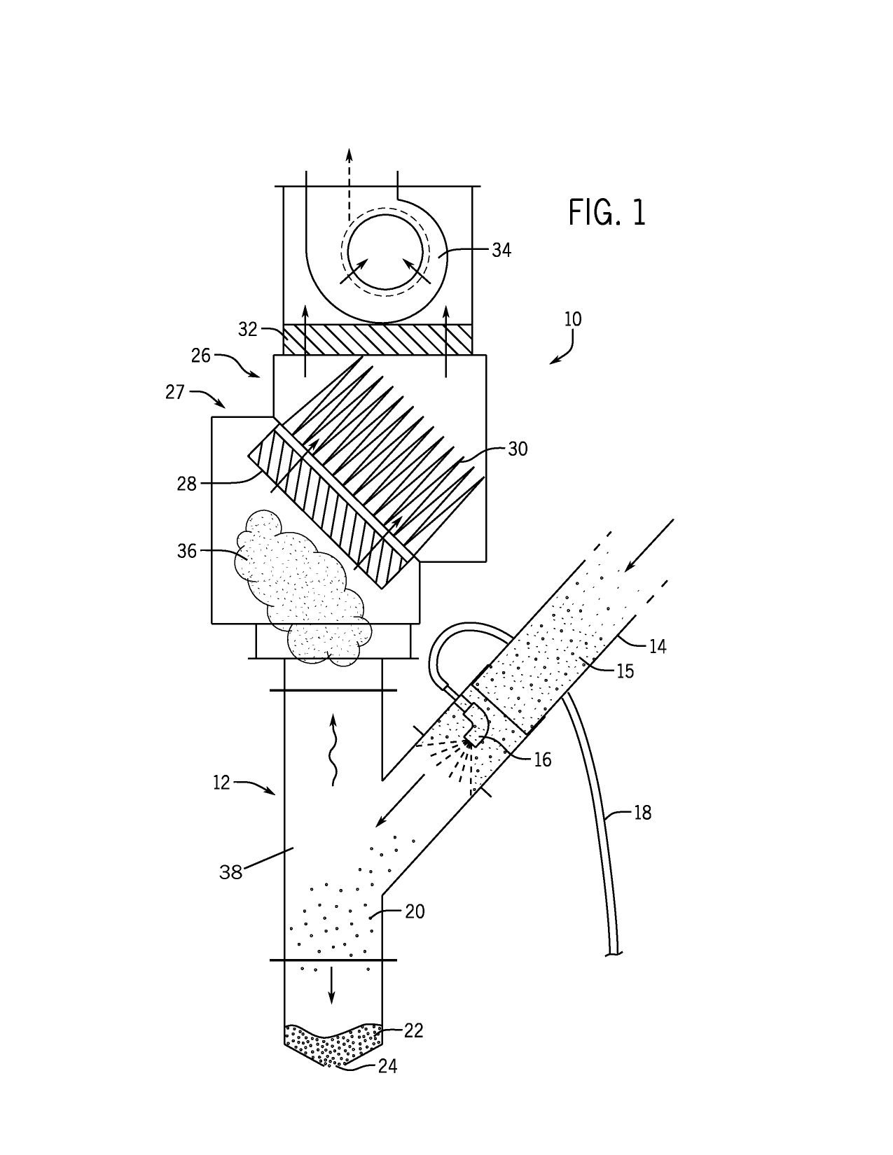

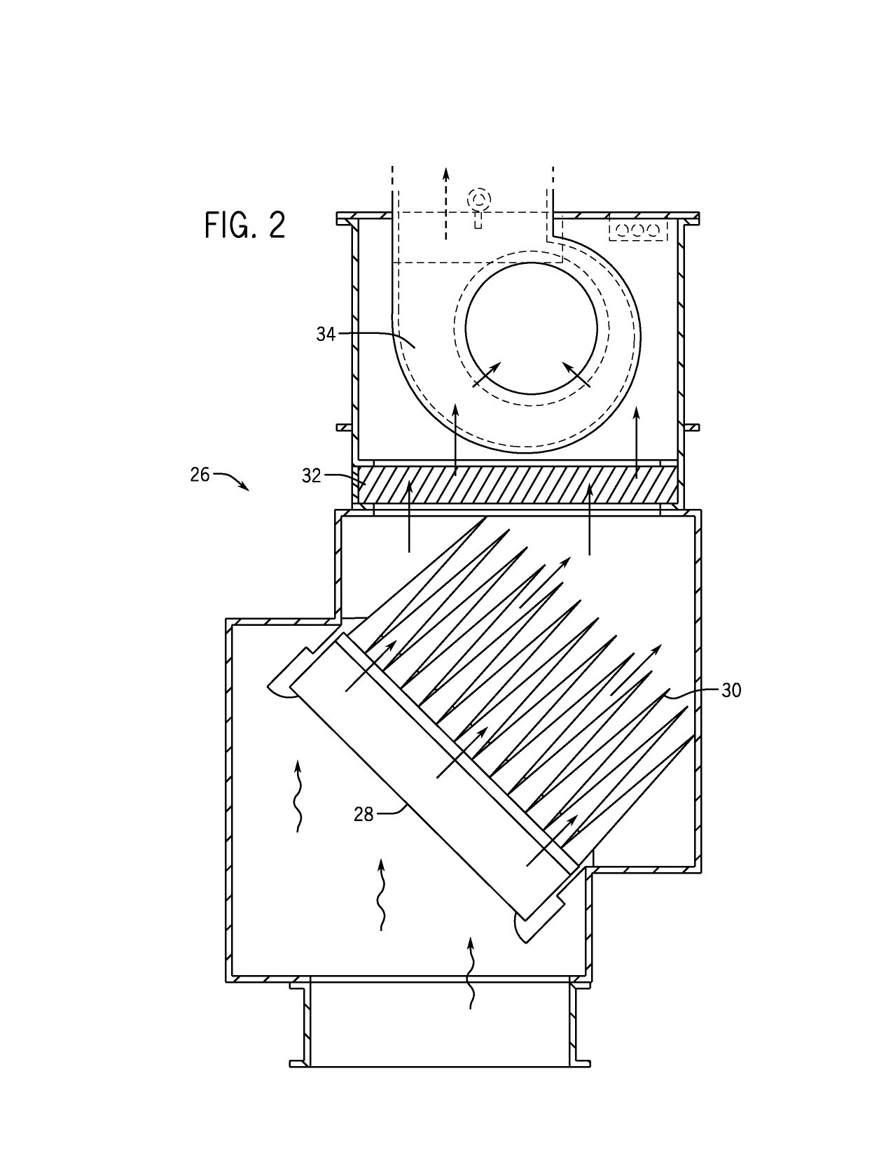

Referring to FIGS. 1 and 2, the present invention may include a filtering device 10. The filtering device 10 may include a mist collecting portion 26. The mist collecting portion 26 may include a housing 27, which may include a top portion and a bottom portion. Contaminated air 15 may enter the filtering device 10 through an intake near the bottom portion of the housing. The contaminated air 15 may be air containing oil, liquids, gases, particulate, or a combination thereof.

Within the housing 27, a coalescing filter 28 may be mounted at an angle. For example, the coalescing filter 28 may be mounted in the housing 27 at an angle, such as around a 45 degree angle, relative to the housing 27. The coalescing filter 28 may be around 6 inches thick. The particles may be forced apart by vortices that occur when the air mass passes through the coalescing filter 28. Due to the mounted 45 degree angle of the coalescing filter 28, as opposed to horizontal or vertical, the liquids may be forced to drain to the front of the proprietary gradient coalescing filter 28.

In certain embodiments, the coalescing filter 23 may include a first layer which may be a channel style filter, similar to a grease filter, to stop high pressure amounts of liquid from entering the filter directly. A second layer of the coalescing filter 28 may include several sheets of expanded and wrinkled metal with openings.

The openings may range from about 0.2 to about 0.3 inches in size. When the airflow laden with liquid droplets hits this layer, vortices occur separating the liquid from the air. A third layer of the coalescing filter 28 may include at least one layer of screen. The screen may be made of stainless steel and may be coated with Polytetrafluoroethylene, such as Teflon®. The screen may include a grid of around 30 wires per inch, which may leave openings of approximately 0.01 inches. The Teflon coated screen may separate even finer droplets of water, which may be the size of 3 microns or smaller. A fourth layer of the coalescing filter 28 may include several more layers of expanded and wrinkled metal with openings from around 0.1 to about 0.2 inches in size.

Once the contaminated air has run through the coalescing filter 28, the moisture may be substantially removed. The dry particulate that remains may be filtered out of the air stream. A bag filter 30 may be oriented adjacent to the coalescing filter, and thereby the dry particulate may be filtered by the bag filter 30. The bag filter 30 may be a 95% filter that may be made of a material that is free flowing, such as fiberglass fabric. In certain embodiments, the bag filter 30 may be attached to and trapped against the coalescing filter 28 so that the filters 28, 30 are sealed together. The air may then flow through a charcoal filter 32, which may be attached within the housing above the bag filter 30. The charcoal filter may remove light gases and odors. The clean air may then be pulled into a blower fan 34 and expelled out of the top of the housing 27.

In certain embodiments, the present invention may include an intake portion 12 that may attach to the intake of the housing 27. The intake portion may include a vertical tube 38 and an intake tube 14. When applications generate heavy particulate, including but not limited to, cast iron or phenolic, the conical nozzle intake tube 14 may be used. The intake tub 14 may include mechanisms that have coolant pumps and tanks to enable the separation of particles from the air without the direct contact of the particles to the filters or the expedient saturation of filter media. For example, contaminated air 15 containing debris, oils, liquids, gases and particulates may enter the intake portion 12 at the intake tube 14. The contaminated air 15 may be drawn by a vacuum created by the filtering device 10, such as by the blower 34. The intake tube 14 may lead the contaminated air 15 to a spray nozzle 16. The spray nozzle may be connected to a liquid source 18. The spray nozzle 16 may spray a liquid, such as water, on to the contaminated air 15.

The angle of the spray pattern may be around 120 degrees, leaning in the direction of the airflow. Debris may be captured in the liquid as it passes through, turning into saturated debris 20. A vertical tubing 38 may be attached to the intake tube 14. The vertical tubing 38 may be oriented vertically towards the intake of the housing 27. The saturated debris 20 naturally becomes heavy and may fall where liquid and debris 22 are gathered and may flow back into the machine. In certain applications a bottom cap vacuum trap 24 may be used in conjunction with the present invention. When liquid cannot be returned to the machine, the bottom trap 24 may act as a trap so that vacuum is not lost between the nozzle area and the mist collector. The bottom trap may include a narrow slot opening which may allow liquid to drain without losing vacuum. The mist 36 from the liquid and debris 20 may travel up the piping, into the housing 27 and into the coalescing filter 28.

The components mentioned above may be made of steel and aluminum sheet. In certain embodiments, the joints between the tubing and housing may be caulked for sealing. The main components may be riveted and bolted together. The filters may be retained by spring loaded clips. Access to the filters may be through bolted on doors of sheet metal. In certain embodiments, the entire assembly is powder coated.

A method of using the present invention may include the following. The filtering device may be mounted on or near an enclosed machine and connected with a hose. The blower inside the filtering device may create a low pressure condition inside the machine that may keep the contaminates inside the machine.

The dustier the application, the benefits of the device may be increased. When using the optional conical intake tube, a portion of the machines coolant may be used to power a nozzle inside the tube, trapping the dust particles in the cone of coolant that is spraying inside so that all the air must pass through the coolant.

The filtering device may be mounted to any machine that uses liquid in its process such as industrial parts, washers and the like. The present invention may also be used to filter a dry process by using an external coolant tank and using the bottom cap vacuum trap to return the liquid and particulate to the external tank instead of routing the liquid back to the machine

It should be understood, of course, that the foregoing relates to exemplary embodiments of the invention and that modifications may be made without departing from the spirit and scope of the invention as set forth in the following claims.

What is claimed is:

1. A filtering device comprising:
a housing having a bottom portion and a top portion, wherein the bottom portion comprises an intake;
a coalescing filter suspended within the housing, wherein the coalescing filter is suspended at an angle relative to the housing; and
a blower attached to near the top portion of the housing, wherein the blower blows air from the housing and thereby creates a vacuum within the housing.

2. The filtering device of claim 1, wherein the coalescing filter is suspended within the housing at around a 45 degree angle.

3. The filtering device of claim 1, wherein the coalescing filter comprises:
a first layer comprising a channel filer;
a second layer comprising a first plurality of sheets of expanded and wrinkled metal comprising openings;
a third layer comprising a screen layer comprising stainless steel and a coating of polytetrafluoroethylene; and
a fourth layer comprising a second plurality of sheets of expanded and wrinkled metal comprising openings.

4. The filtering device of claim 3, wherein the screen layer comprises openings around 0.01 inches in diameter.

5. The filtering device of claim 3, wherein the openings of the first plurality of sheets are from about 0.2 to about 0.3 inches in size.

6. The filtering device of claim 3, wherein the openings of the second plurality of sheets are from about 0.1 to about 0.2 inches in size.

7. The filtering device of claim 1, further comprising a bag filter comprising a fiberglass fabric, wherein the bag filter is airtight sealed to a top of the coalescing filter.

8. The filtering device of claim 1, further comprising a charcoal filter attached to the housing in between the bag filter and the blower.

9. The filtering device of claim 1, further comprising an intake portion attached to the intake of the housing.

10. The filtering device of claim 8, wherein the intake portion comprises:
an intake tube comprising a spray nozzle configured to spray a liquid, wherein a contaminate debris enters the intake tube and is sprayed with liquid by the spray nozzle creating a saturated debris and a mist;
a vertical tube connected to the intake tube, wherein the intake tube is oriented at an angle relative to the vertical tube, wherein the vertical tube comprises a top end and a bottom end, wherein the top end is connected to the intake of the housing, and wherein the mist enters the housing through the top end; and
a bottom trap comprising an opening, wherein the saturated debris is collected at the bottom trap and exits through the opening.
